(19) United States
(12) Patent Application Publication
(10) Pub. No.: US 2004/0049560 A1
(43) Pub. Date: Mar. 11, 2004

(54) Method and apparatus for configuring a computer system to operate with perhiperal devices

(76) Inventors: Shudong Zhou, Fremont, CA (US); John H. Danielson, San Francisco, CA (US); Jerry A. Gilliam, Santa Clara, CA (US); Christopher T. Horne, Boulder, CO (US); Jan Setje-Eilers, Redwood City, CA (US); Vikram Hegde, North York (CA)

Correspondence Address: PARK, VAUGHAN & FLEMING LLP, 508 SECOND STREET, SUITE 201, DAVIS, CA, 95616, US

(21) Appl. No.: 10/237,942

(22) Filed: Sep. 9, 2002

(51) Int. Cl. G06F 15/177

(52) U.S. Cl. 709/220

(57) ABSTRACT

One embodiment of the present invention provides a system that uses a file system operation to drive the process of configuring a computer system to operate with a device. During operation, the system receives an access request for the device. If a driver for the device has not been previously loaded, the system loads the driver for the device. Next, the system creates an instance of the driver for the device and attaches the instance so that the computer system is able to access the device. Finally, the system accesses the device to satisfy the request. In a variation of this embodiment, the access request specifies a path for the device, wherein the path includes one or more path components. Before loading the driver, the system first parses the path to identify the driver for the device as well as an address for the device from a path component. The system uses this address to identify the device prior to creating the instance of the driver for the device.

### BACKGROUND

1. Field of the Invention

The present invention relates to the process of configuring a computer system to operate with peripheral devices. More specifically, the present invention relates to a method and an apparatus for using file system operations to drive the process of configuring a computer system to operate with peripheral devices.

2. Related Art

Advances in computer networking technology presently make it possible for a computer system to access numerous peripheral devices coupled to a computer network. These peripheral devices may reside at different physical locations. For example, some of them may be located within the same room as the computer system, while other devices are located at different geographical locations. However, in order to access these peripheral devices, the computer system must first be configured to operate with each different type of peripheral device.

In existing systems, the process of configuring a computer system to operate with different peripheral devices takes place during system boot time. During system boot time, the computer system first discovers all of the available peripheral devices, and then loads device drivers for the devices. The system also creates an instance of the driver for each device. If a new device is subsequently added to the computer system after boot time, the computer system is typically rebooted to load the appropriate driver and to create an instance of the driver for the device.

While this method of configuration is effective for stand-alone computer systems with dedicated peripheral devices, it is less effective for distributed computing systems that can access many different types of networked peripheral devices. Note that the availability of these networked devices can change from time to time as available portions of the network change and when peripherals are added to or removed from the network. Hence, the process of discovering all of the devices on the network can consume an inordinate amount of time, thereby causing the computer system to be slow to boot. Also, the process of reconfiguring the computer system to reflect the ever-changing status of the network is a difficult task. Moreover, maintaining the data structures required to access devices that have been removed from the network, or that may not be required for a particular system, can waste resources that can be used for other purposes. For example, a system that has one thousand disks on the network maintains the configuration for all of these disks although only a few may actually be used by the system.

What is needed is a method and an apparatus that allows peripheral devices to be configured without the problems described above.

### SUMMARY

One embodiment of the present invention provides a system that uses a file system operation to drive the process of configuring a computer system to operate with a device. During operation, the system receives an access request for the device. If a driver for the device has not been previously loaded, the system loads the driver for the device. Next, the system creates an instance of the driver for the device and attaches the instance so that the computer system is able to access the device. Finally, the system accesses the device to satisfy the request.

In a variation of this embodiment, the access request specifies a path for the device, wherein the path includes one or more path components. Before loading the driver, the system first parses the path to identify the driver for the device as well as an address for the device from a path component. The system uses this address to identify the device prior to creating the instance of the driver for the device.

In a further variation, the system generates a data structure for the device and returns a reference to the data structure.

In a further variation, the system repeats the steps of parsing the path, loading the driver, identifying the device, creating the instance of the driver, attaching the instance, and creating the data structure for each component of the path.

In a further variation, the path includes multiple path components.

In a further variation, the device is coupled to a local computer system.

In a further variation, the device is coupled to a network accessible by a local computer system.

In a further variation, the network includes the Internet.

In a further variation, the device is coupled to a switched fabric.

In a further variation, the system deletes the data structure when the data structure is no longer needed.

### BRIEF DESCRIPTION OF THE FIGURES

FIG. 1 illustrates a computer system in accordance with an embodiment of the present invention.

FIG. 2 illustrates components of a system associated with peripheral devices in accordance with an embodiment of the present invention.

FIG. 3 illustrates devices coupled together in accordance with an embodiment of the present invention.

FIG. 4 illustrates the structure of device driver configuration information in accordance with an embodiment of the present invention.

FIG. 5 is a flowchart illustrating loading and configuring device drivers in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

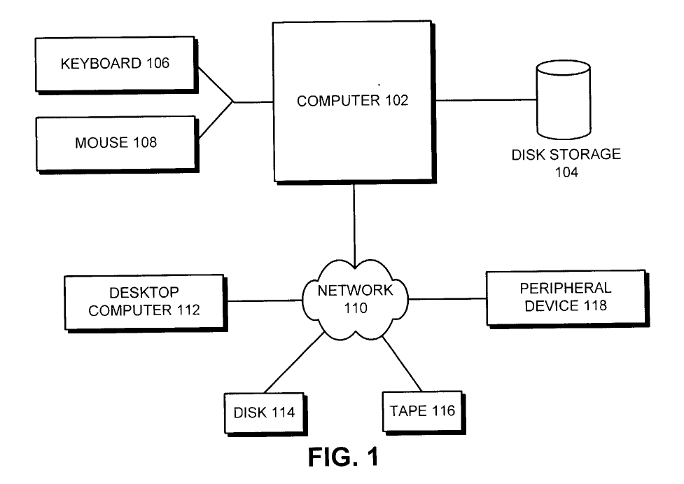

FIG. 1 illustrates a computer system 102 in accordance with an embodiment of the present invention. Computer system 102 can generally include any type of computer system, including, but not limited to, a computer system based on a microprocessor, a mainframe computer, a digital signal processor, a portable computing device, a personal organizer, a device controller, and a computational engine within an appliance. Computer system 102 includes computer 102, keyboard 106, mouse 108, and disk storage 104. Computer 102 is additionally coupled to desktop computer 112, disk 114, tape 116, and peripheral device 118 through network 110.

Keyboard 106 and mouse 108 are data entry devices that are coupled to computer 102. Disk storage 104 provides persistent storage for computer 102.

Network 110 can generally include any type of wire or wireless communication channel capable of coupling together computing nodes. This includes, but is not limited to, a local area network, a wide area network, or a combination of networks. In one embodiment of the present invention, network 110 includes the Internet. In another embodiment of the present invention, network 110 includes a switched fabric.

Desktop computer 112 can be coupled to computer 102 across network 110 and can serve as a data entry or a data display device. Disk 114 and tape 116 provide persistent storage for computer 102. Note that disk 114 and/or tape 116 can represent zero or more of these peripheral devices.

Peripheral device 118 represents other peripheral devices that can be coupled to computer 102 across network 110. These other peripheral devices include scanners, plotters, and the like. Note that peripheral device 118 also represents zero or more of these peripheral devices.

Coupling to Hardware Devices

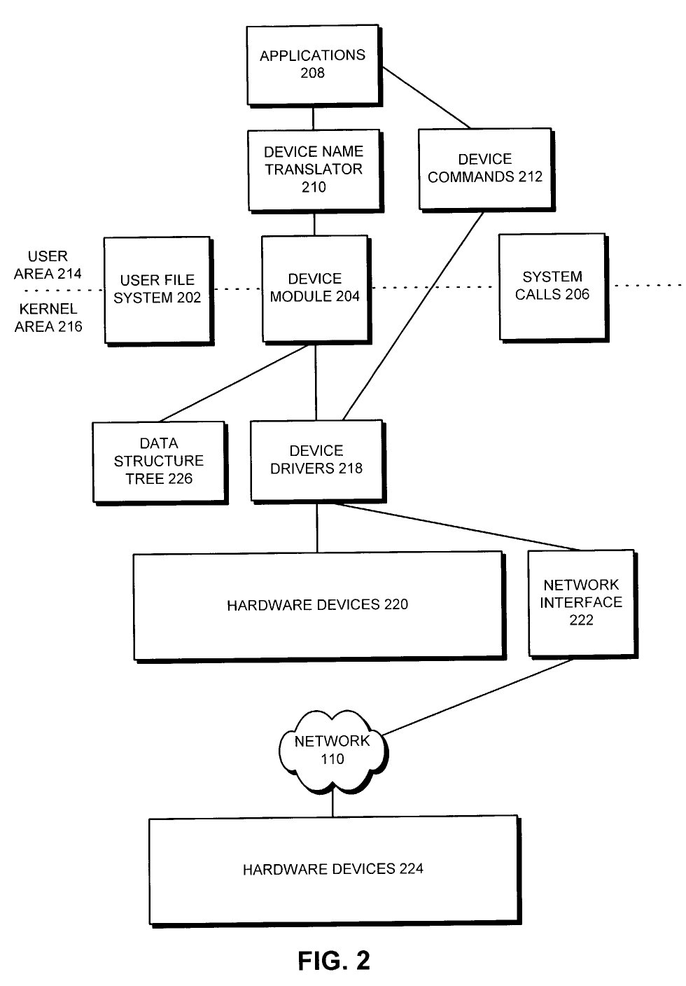

FIG. 2 illustrates data structures associated with peripheral devices in accordance with an embodiment of the present invention. The system illustrated in FIG. 2 is separated into user area 214 and kernel area 216. User area 214 includes applications 208, device name translator 210, device commands 212, and portions of user file system 202, device module 204, and system calls 206.

Kernel area 216 include the remaining portions of user file system 202, device module 204, and system calls 206 as well as data structure tree 226, device drivers 218, network interface 222, network 110, and hardware devices 220 and 224.

Applications 208 include computer programs executing on computer 102 and needing access to peripheral devices. During operation, applications 208 issue commands such as read, write, open, and close to the peripheral devices to control the operation of these devices.

For example, applications 208 address the peripheral devices using device paths such as “/devices/pci@1f,0/pci@1,1/ide@3/dad@0,0:a.” This device path addresses a disk coupled to computer 102. Device name translator 210 translates this device path into the required information for device module 204 to locate the device and to couple the proper driver to device module 204 and to access the device.

Device commands 212 are direct commands issued by applications 208, which communicate with device drivers 218 to control the devices. Device commands 212 include commands known as input/output control (ioctl) commands.

Device drivers 218 provide software links between device module 204 and the various hardware devices, such as hardware devices 220 and 224. During operation, if a device driver has not been loaded for a particular hardware device, device module 204 dynamically loads the device driver for the device. Device module 204 can also remove the device driver for any devices that are no longer required by applications 208 or that have become unavailable to applications 208.

Data structure tree 226 organizes the data structures related to device drivers 218 and provides the necessary data to access these devices. Data structure tree 226 is maintained as described below.

Hardware devices 220 includes peripheral devices that are directly coupled to computer 102 while hardware devices 224 include peripheral devices that are accessible across network 110. The location of a hardware device is transparent to applications 208. Device drivers 218 are responsible for locating and communicating with a hardware device whether it is located within hardware devices 220 or hardware devices 224. Network interface 222 couples network 110 to device drivers 218.

Device Coupling

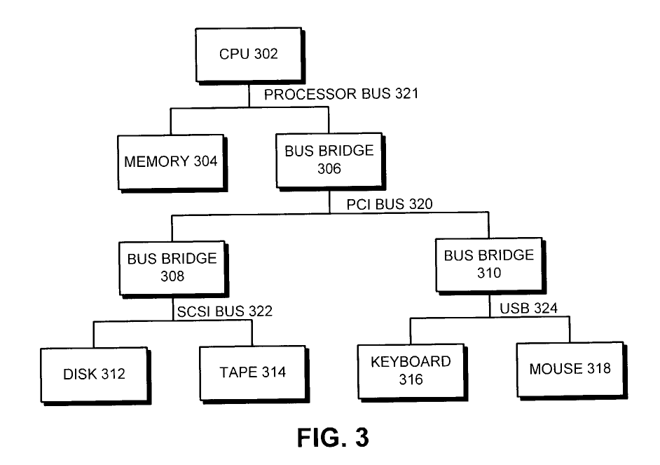

FIG. 3 illustrates devices coupled together in accordance with an embodiment of the present invention. As illustrated in FIG. 3, central processing unit (CPU) 302 is coupled to memory 304 and bus bridge 306 by processor bus 321. Note that other devices can be coupled to processor bus 321.

Bus bridge 306 couples processor bus 321 to peripheral component interconnect (PCI) bus 320. PCI bus 320 couples bus bridges 308 and 310 to bus bridge 306. PCI bus 320 can also couple to peripheral devices and to additional bus bridges for coupling to other bus structures such as an IDE bus.

Bus bridge 308 couples PCI bus 320 to SCSI bus 322, while bus bridge 310 couples PCI bus 320 to USB 324. Individual peripheral devices such as disk 312, tape 314, keyboard 316, and mouse 318 are coupled to the system through these various buses. Note that these peripherals are representative of the peripherals that can be coupled to the system. There can be more types of peripherals and more of each type than shown. The peripherals can also be coupled to the system across a network.

Device Driver Configuration

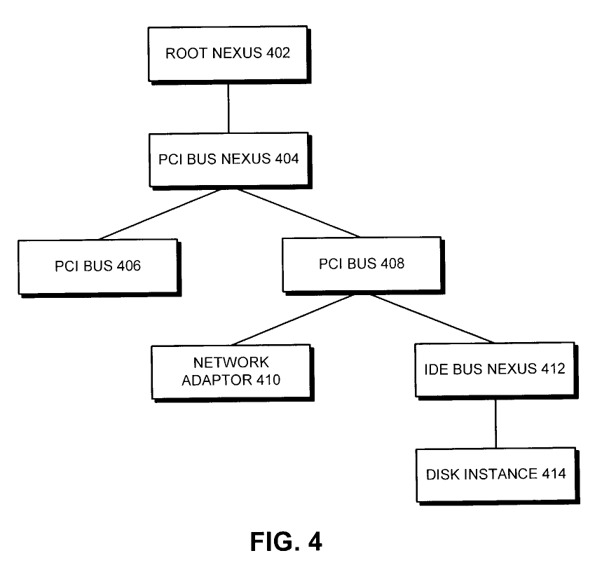

FIG. 4 illustrates device driver configuration in accordance with an embodiment of the present invention. This device driver configuration is stored in data structure tree 226 and is referenced by device module 204 when adding and deleting drivers for specific hardware devices. Data structure tree 226 has its root at root nexus 402. As new devices are added, the tree is built to reflect the hierarchical architecture of the various drivers, buses, and adaptors.

As shown in FIG. 4, PCI bus nexus 404 is coupled to root nexus 402. PCI bus nexus 404 can couple to multiple PCI buses such as PCI buses 406 and 408. Each PCI bus can, in turn, be coupled to peripherals or to other buses. In FIG. 4, PCI bus 408 is coupled to network adaptor 410 and IDE bus nexus 412. Network adaptor 410 can couple devices located on network 110 to the system while IDE bus nexus 412 can couple IDE devices such as disk instance 414 to the system. Note that the structure of data structure tree 226 is dynamic and changes as peripherals are needed by the system or as the peripherals are no longer needed or available to the system.

Also note that the present invention is not meant to be limited to a tree structure as is illustrated in FIG. 4. In general, the present invention can be applied to any topology for interconnecting system components.

Loading and Configuring Device Drivers

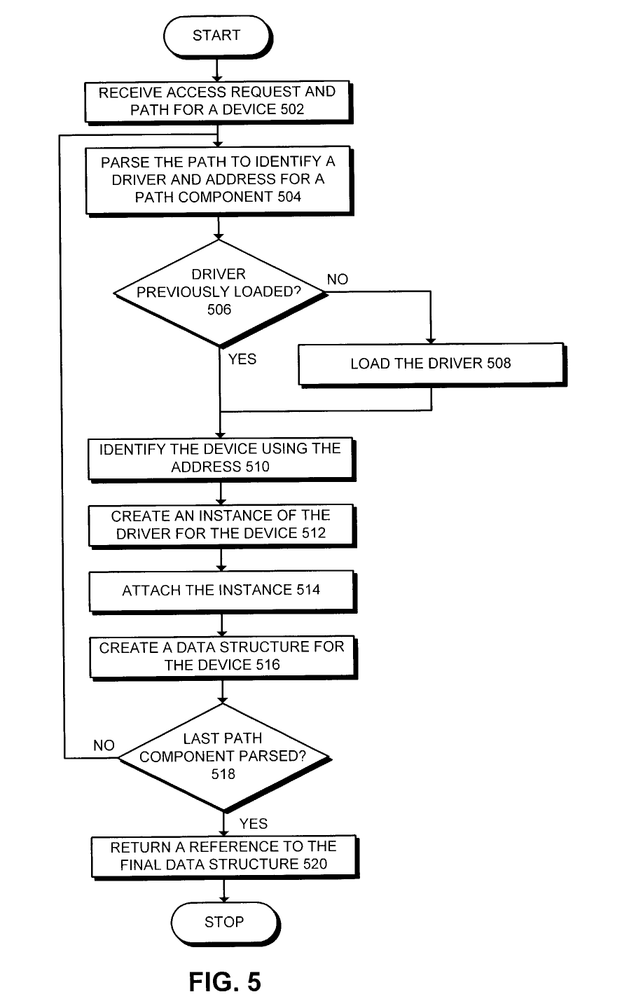

FIG. 5 is a flowchart illustrating loading and configuring device drivers in accordance with an embodiment of the present invention. Unlike in conventional systems that load and configure device drivers at system initialization time, the system starts when an access request is received to access a device (step 502). This request includes a path for the device. For example, an IDE disk drive, in the form of: “/devices/pci@1f,0/pci1,1/ide@3/dad@0,0:a.”

Next, the system parses the path to identify a driver and address for a path component (step 504). A component of the path, for example “pci@1f,0”, includes a driver name and an address. In the example, the driver name is “pci” and the address is “1f0” indicating that the device can be found coupled to a PCI bus with an address of 1f,0.

The system then determines whether the driver has been previously loaded (step 506). If not, the system loads the driver before proceeding (step 508). Once the driver is available, the system identifies the device using the address (step 510). Next, the system creates an instance of the driver for the device (step 512) and attaches the instance (step 514). The system then creates a data structure entry for the device (step 516).

After the data structure for the device has been created, the system determines if the last path component has been parsed (step 518). If not, the process returns to step 504 to continue parsing the path and installing drivers until the last path component has been parsed. Finally, after the last path component has been parsed, the system returns a reference for the final data structure to the application (step 520). At this point, the path for the device is complete and application is able to access the device.

Note that the process of configuring device drivers in this way speeds up the system initialization process because device drivers do not have to be configured during system initialization. However, waiting until a device is accessed by the application to configure the device driver requires extra time when the device is first accessed by the application.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for configuring a computer system to operate with a device, comprising:
receiving an access request for the device;
if a driver for the device has not been previously loaded, loading the driver for the device;
creating an instance of the driver for the device;
attaching the instance so that the computer system is able to access the device; and
accessing the device to satisfy the request.

2. The method of claim 1,
wherein the access request specifies a path for the device, wherein the path including one or more path components;
wherein loading the driver involves first parsing the path to identify the driver and an address from a path component; and
wherein creating the instance of the driver for the device involves first identifying the device using the address.

3. The method of claim 2, further comprising:
generating a data structure for the device; and
returning a reference to the data structure.

4. The method of claim 3, further comprising repeating the steps of parsing the path, loading the driver, identifying the device, creating the instance of the driver, attaching the instance, and creating the data structure for each component of the path.

5. The method of claim 3, wherein the path includes multiple path components.

6. The method of claim 3, wherein the device is coupled to a local computer system.

7. The method of claim 3, wherein the device is coupled to a network accessible by a local computer system.

8. The method of claim 7, wherein the network includes the Internet.

9. The method of claim 3, wherein the device is coupled to a switched fabric.

10. The method of claim 3, further comprising deleting the data structure when the data structure is no longer needed.

11. A computer-readable storage medium storing instructions that when executed by a computer cause the computer to perform a method to facilitate device configuration on-the-fly, the method comprising:
receiving an access request for the device;
if a driver for the device has not been previously loaded, loading the driver for the device;
creating an instance of the driver for the device;
attaching the instance so that the computer system is able to access the device; and
accessing the device to satisfy the request.

12. The computer-readable storage medium of claim 11,
wherein the access request specifies a path for the device, wherein the path including one or more path components;
wherein loading the driver involves first parsing the path to identify the driver and an address from a path component; and
wherein creating the instance of the driver for the device involves first identifying the device using the address.

13. The computer-readable storage medium of claim 12, the method further comprising:
generating a data structure for the device; and
returning a reference to the data structure.

14. The computer-readable storage medium of claim 13, the method further comprising repeating the steps of parsing the path, loading the driver, identifying the device, creating the instance of the driver, attaching the instance, and creating the data structure for each component of the path.

15. The computer-readable storage medium of claim 13, wherein the path includes multiple path components.

16. The computer-readable storage medium of claim 13, wherein the device is coupled to a local computer system.

17. The computer-readable storage medium of claim 13, wherein the device is coupled to a network accessible by a local computer system.

18. The computer-readable storage medium of claim 17, wherein the network includes the Internet.

19. The computer-readable storage medium of claim 13, wherein the device is coupled to a switched fabric.

20. The computer-readable storage medium of claim 13, the method further comprising deleting the data structure when the data structure is no longer needed.

21. An apparatus to facilitate device configuration on-the-fly, comprising:
a receiving mechanism that is configured to receive an access request for a device;
a loading mechanism that is configured to load a driver for the device;
a creating mechanism that is configured to create an instance of the driver for the device;
an attaching mechanism that is configured to attach the instance.
receiving an access request for the device so that the computer system is able to access the device; and
an accessing mechanism that is configured to access the device to satisfy the request.

22. The apparatus of claim 21,
wherein the access request specifies a path for the device, wherein the path including one or more path components; and
wherein the apparatus further comprises:
a parsing mechanism that is configured to parse the path to identify the driver and an address from a path component, and
an identifying mechanism that is configured to identify the device using the address.

23. The apparatus of claim 22, further comprising a data structure mechanism that is configured to:
generate a data structure for the device; and to
return a reference to the data structure.

24. The apparatus of claim 23, further comprising a repeating mechanism that is configured to repeat the steps of parsing the path, loading the driver, identifying the device, creating the instance of the driver, attaching the instance, and creating the data structure for each component of the path.

25. The apparatus of claim 23, wherein the path includes multiple path components.

26. The apparatus of claim 23, wherein the device is coupled to a local computer system.

27. The apparatus of claim 23, wherein the device is coupled to a network accessible by a local computer system.

28. The apparatus of claim 27, wherein the network includes the Internet.

29. The apparatus of claim 23, wherein the device is coupled to a switched fabric.

30. The apparatus of claim 23, further comprising a deleting mechanism that is configured to delete the data structure when the data structure is no longer needed.
